(19) United States
(12) Patent Application Publication
(10) Pub. No.: US 2008/0055178 A1
(43) Pub. Date: Mar. 6, 2008

(54) BROAD BAND ANTENNA

(75) Inventors: In Young KIM, Gyunggi-do (KR); Seok Bae, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/848,862

(22) Filed: Aug. 31, 2007

(30) Foreign Application Priority Data
Sep. 4, 2006 (KR) 10-2006-84698

(51) Int. Cl. H01Q 1/00

(52) U.S. Cl. 343/787

(57) ABSTRACT

A broad band antenna including: a body formed of a material having a relative permittivity of 2 to 20, a relative permeability of 1 to 10, and a magnetic loss tangent of 0.001 to 0.2, at a usable frequency; and at least one radiator disposed on the body. The material forming the body may be a composite material formed of a polymer resin mixed with a magnetic powder. The composite material may contain the magnetic powder by 90 wt % with respect to a total weight.

### CROSS-REFERENCE TO RELATED APPLICATIONS

This application claims the priority of Korean Patent Application No. 2006-84698 filed on Sep. 4, 2006, in the Korean Intellectual Property Office, the disclosure of which is incorporated herein by reference.

### BACKGROUND OF THE INVENTION

1. Field of the Invention

The present invention relates to a broad band antenna, more particularly, which can be miniaturized using a magnetic substance without considerable decline in gain.

2. Description of the Related Art

Of late, a broadcasting service is provided to a mobile telecommunication terminal or information is transmitted wirelessly between a personal computer and a terminal, or between terminals. That is, wireless telecommunication has been commonly available. Also, diversity in information has led to a broader band of a usable frequency employed in telecommunication between devices. With this trend, broadband characteristics of an antenna have gained importance.

A representative example of a broad band antenna currently manufactured includes a helical antenna, a spiral antenna and a log periodic antenna. In order to realize a compact broad band antenna, bandwidth may be increased by applying a log periodic design to a patch antenna or utilizing a multilayer structure. Also, multi-resonance may be generated by a planar inverted F antenna (PIFA). Alternatively, an antenna may be switch-connected to be adjusted in a band, which is however not suited to the small-sized antenna due to decrease in gain.

Especially, a terrestrial broadcasting antenna for a mobile telecommunication terminal has a usable frequency band of 200 to 750 MHz, which is lower than a typical communication frequency. But the antenna has a size proportional to a wavelength of a usable frequency. Thus, with decrease in the usable frequency, the antenna is sized bigger. But the antenna with bigger size does not serve its purpose as a part of a mobile telecommunication terminal. On the contrary, the antenna with smaller size may be degraded in gain or bandwidth. Therefore, it is crucial to implement a compact broad band antenna at a relatively low frequency band.

As described above, the currently needed antenna characteristics can be hardly achieved only with structural changes in design. In the art, a new approach for addressing this technological issue has been called for.

### SUMMARY OF THE INVENTION

An aspect of the present invention provides a novel broad band antenna which can be miniaturized using a magnetic substance and controlled in magnetic loss of an antenna body, thereby attaining broadband characteristics without a big decrease in gain.

According to an aspect of the present invention, there is provided a broad band antenna including: a body formed of a material having a relative permittivity of 2 to 20, a relative permeability of 1 to 10, and a magnetic loss tangent of 0.001 to 0.2, at a usable frequency; and at least one radiator disposed on the body.

The material forming the body may be a composite material formed of a polymer resin mixed with a magnetic powder. The composite material may contain the magnetic powder by 90 wt % with respect to a total weight.

The magnetic powder may be a magnetic substance having at least one element selected from Fe, Ni, Co, Mn, Mg, Ba, Sr and Zn. The magnetic powder may be at least one selected from carbonyl iron, a Ba ferrite, a NiZn ferrite and a MnZn ferrite.

The magnetic powder may be the carbonyl iron and the composite material may contain the magnetic powder by 45 to 85 wt % with respect to a total weight.

The magnetic powder may be the NiZn ferrite and the composite material may contain the magnetic powder by 45 to 90 wt % with respect to a total weight.

The magnetic powder may be the Ba ferrite and the composite material may contain the magnetic powder by 50 to 87.5 wt % with respect to a total weight.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a sample of an antenna structure for evaluating a material forming a broad band antenna body, applicable according to an exemplary embodiment of the invention;

FIGS. 2A and 2B are graphs illustrating dielectric properties and magnetic properties of a body-forming material applicable to a broad band antenna, respectively, according to an exemplary embodiment of the invention;

FIG. 3 is a perspective view illustrating an antenna structure employed in first to third examples of the present invention;

FIG. 4 is a graph illustrating frequency characteristics of a broad band antenna formed of a composite material containing carbonyl iron according to the first example of the present invention;

FIGS. 5A and 5B are graphs illustrating frequency characteristics of a broad band antenna formed of a composite material containing a NiZn ferrite and gain characteristics adjusted by a matching circuit, respectively, according to the second example of the present invention; and

FIGS. 6A and 6B are graphs illustrating frequency characteristics of a broad band antenna formed of a Ba ferrite and gain characteristics adjusted by a matching circuit, respectively, according to the third example of the present invention.

### DETAILED DESCRIPTION OF THE PREFERRED EMBODIMENT

According to the present invention, a magnetic substance is at least partially applied to an antenna body to utilize both permittivity and permeability, thereby more easily producing a smaller antenna. Hereinafter, a detailed description will be given based on following Equations.

$$λ = \frac{{λ}_{0}}{\sqrt{ɛμ}} \qquad Equation 1$$

where λ is a wavelength of an actual frequency, λ₀ is a wavelength determined by a radiator, ∈ is relative permittivity of the body and μ is relative permeability of the body. As noted in Equation 1, a wavelength of a final frequency is inversely proportional to permittivity and permeability. Therefore, the wavelength of the final frequency can be further shortened by utilizing permittivity and permeability as well.

Particularly, as shown in Equation 2 below, a wavelength impedance η of the body is increased with increase in permittivity. This causes a field to be confined inside the material and lowers gain of the antenna. Here, η₀ is a wavelength impedance in a free space.

$$η = {η}_{0} \sqrt{\frac{μ}{ɛ}} \qquad Equation 2$$

Also, increase only in permittivity leads to decrease in bandwidth of the antenna, thus considerably hampering design of a broad band antenna. As described above, the permittivity, when employed alone, may be disadvantageous for antenna characteristics.

As described above, according to the present invention, the antenna is reduced in size and improved in gain by using both permittivity and permeability. Furthermore, according to the present invention, magnetic loss of the body is controlled to increase bandwidth of the antenna, without significantly undermining radiation efficiency.

The antenna bandwidth is governed by a quality factor Q according to following Equation 3:
FBW[%]=Δf/f=1/Q Equation 3

The Q value is determined by loss of the antenna radiator, dielectric loss and magnetic loss. According to the present invention, a magnetic substance is adopted and magnetic loss of a body-forming material is used to design a smaller broad band antenna without a decrease in gain and radiation efficiency.

Through repeated experiments (refer to first embodiment) based on the aforesaid novel concept, the inventors propose that an antenna body with at least one radiator disposed thereon be formed of a material having a relative permittivity of 2 to 20, a relative permeability of 1 to 10, and a magnetic loss tangent of 0.001 to 0.2, at a usable frequency. The magnetic loss tangent may be adequately increased to noticeably improve bandwidth of the antenna without addition of size. However, the magnetic loss tangent greater than 0.2 may degrade radiation efficiency excessively.

The body-forming material satisfying the aforesaid conditions according to the present invention may be easily manufactured by filling a magnetic powder, with a polymer resin as a matrix. In general, the magnetic substance obtained by sintering is one of ceramic materials and thus greatly brittle. Especially, the magnetic substance, when applied to a mobile telecommunication terminal, may not satisfy a reliability condition such as a drop test. However, a composite material having the magnetic powder filled in the polymer resin may solve such a problem.

Hereinafter, the present invention will be described in detail by way of embodiments.

### Example 1

In first example, antennas were manufactured with materials satisfying permittivity, permeability and magnetic loss characteristics. Then, radiation efficiency, bandwidth and a size reduction ratio of the antennas were measured to confirm improvement effects according to the present embodiment.

In the first example, body-forming materials were constructed to carry maximum properties to identify subsequent effects therefrom. The first example adopted as a basic model a monopol antenna including a rectangular parallelepiped block 11 (L×W×T=73×4×4 cm) surrounding a radiator, i.e., Cu conductive line 12. Then, the body-forming materials noted in Table 1 were prepared to be manufactured into respective rectangular parallelepiped blocks and then antennas each satisfying a central frequency band of 520 MHz.

As seen in Table 1, composite materials of dielectric and magnetic substances or sintered magnetic substances employed in Inventive Examples 1 to 6 satisfy permittivity, permeability and magnetic loss tangent of the present embodiment. Comparative Example 1 employed an antenna in the form of only a Cu conductive line without a body, i.e., the Cu conductive line in air, to have a central frequency of 520 MHz. In Comparative Example 2, a body was manufactured using FR4, a chief material for a conventional printed circuit board.

TABLE 1

| | | | | Dielec- | |
|---|---|---|---|---|---|
| | | Permit- | Perme- | tric | Magnet- |
| | Body-forming | tivity | ability | loss | ic loss |
| | material | (ε) | (μ) | (tan δ_{ε}) | (tan δ_{μ}) |
| Inventive 1 | Carbonyl iron | 4.7 | 1.7 | 0.044 | 0.161 |
| | (50 wt %) + | | | | |
| | silicone resin | | | | |
| Inventive 2 | Carbonyl iron | 7.9 | 2.8 | 0.040 | 0.144 |
| | (75 wt %) + | | | | |
| | silicone resin | | | | |
| Inventive 3 | Carbonyl iron | 9.9 | 3.5 | 0.066 | 0.140 |
| | (83.3 wt %) + | | | | |
| | silicone resin | | | | |
| Inventive 4 | Carbonyl iron | 12.5 | 4.2 | 0.081 | 0.142 |
| | (87.5 wt %) + | | | | |
| | silicone resin | | | | |
| Inventive 5 | M-type Ba | 5.6 | 1.2 | 0.039 | 0.155 |
| | ferrite | | | | |
| | (50 wt %) + | | | | |
| | silicone resin | | | | |
| Inventive 6 | NiZn ferrite | 11 | 7 | 0.001 | 0.040 |
| | pellet | | | | |
| Comparative | Air | 1 | 1 | 0 | 0 |
| 1 | | | | | |
| Comparative | FR4 | 4.4 | 1 | 0.01 | 0 |
| 2 | | | | | |

More specifically, according to Inventive Examples 1 to 4, to manufacture the antenna, carbonyl iron was mixed with a silicone resin by 50 wt %, 75 wt %, 83.3 wt %, and 87.5 wt % with respect to a total weight of each of the body-forming materials, respectively. Here, a small amount of dispersant and superplasticizer were also used. In Inventive Example 5, a M-type Ba ferrite was mixed with a silicone resin by about 50 wt % to produce an antenna similar to Inventive Examples 1 to 4. In Inventive Example 6, a NiZn ferrite pellet was employed, unlike the aforesaid composite material.

Antennas having bodies formed of the materials noted in Table 1 above, were manufactured to measure radiation efficiency, bandwidth and a size reduction ratio thereof. The antennas exhibited a bandwidth with a voltage standing wave ratio (VSWR) of 3 or less. The size reduction ratio was measured by determining a ratio of a length l of each conductive line with respect to a length of the antenna in the form of a Cu conductive line in air. The results are shown in Table 2.

TABLE 2

| | | Size | |
|---|---|---|---|
| | Radiation | reduction | |
| | efficiency | ratio | |
| | (n, %) | (%) | Bandwidth (MHz) |
| Inventive 1 | 90.27 | 68.06 | 55.70 |
| Inventive 2 | 79.02 | 62.83 | 67.00 |
| Inventive 3 | 70.77 | 56.54 | 65.10 |
| Inventive 4 | 60.47 | 49.21 | 80.50 |
| Inventive 5 | 96.37 | 76.44 | 59.35 |
| Inventive 6 | 94.21 | 58.12 | 48.10 |
| Comparative 1 | 96.82 | 100 | 83.00 |
| Comparative 2 | 95.08 | 76.44 | 51.90 |

The antenna of Inventive Example 6 utilizing a sintered magnetic substance was slightly decreased in bandwidth. Meanwhile, the antennas of Inventive Examples 1 to 5 showed a broad bandwidth of about 55 MHz or more, even 80 MHz or more. The antennas of Inventive Examples 1 to 5 also exhibited a high size reduction ratio of 30% or more, and even 50% or more. This confirms that the materials satisfying conditions of the present invention, when used to form the body of the antenna, assure a miniaturizable broad band antenna.

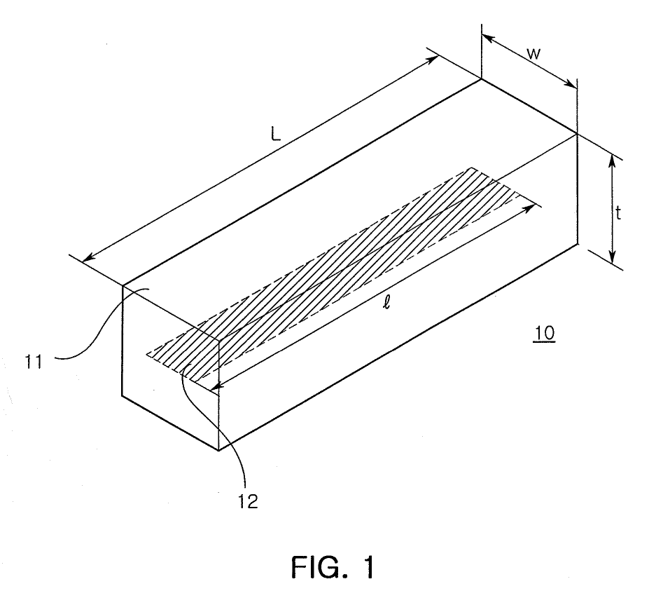

Here, the antennas of Inventive Examples were slightly lowered in radiation efficiency. However, as shown in FIG. 1, the measurement was designed to evaluate characteristics of the body-forming materials, and thus the materials were constructed to fully surround the radiator 12. Therefore, the modest decrease in radiation efficiency is insignificant since higher radiation efficiency is expected from an actually implemented antenna structure, i.e., an antenna having a radiator disposed on a surface of a body.

As described above, according to Inventive Examples, magnetic loss is adequately controlled under proper conditions of permittivity and permeability. In consequence, it has been confirmed that this increases bandwidth while not significantly degrading radiation efficiency, and also noticeably reduces size of the antenna.

The body-forming material applicable to the present embodiment may have a magnetic loss tangent of 0.001 to 0.2 under the permittivity and permeability conditions as described above. Accordingly, the body-forming material may adopt a sintered magnetic substance satisfying the permittivity, permeability and magnetic loss conditions.

Particularly, the body-forming material may utilize a soft magnetic composite material having a magnetic substance and a polymer resin mixed therein to enhance mechanical reliability and easily design desired dielectric properties and magnetic conditions. A magnetic powder applicable to the present embodiment may be a magnetic substance having at least one element selected from Fe, Ni, Co, Mn, Mg, Ba, Sr and Zn. One of carbonyl iron, a Ba ferrite, a NiZn ferrite and a MnZn ferrite may be utilized more beneficially for the magnetic powder.

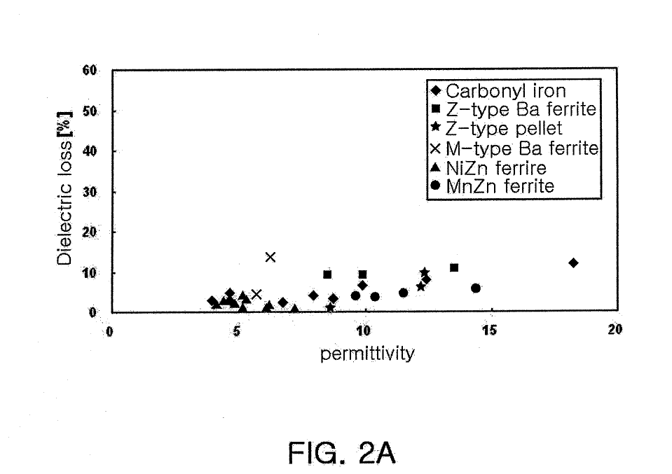

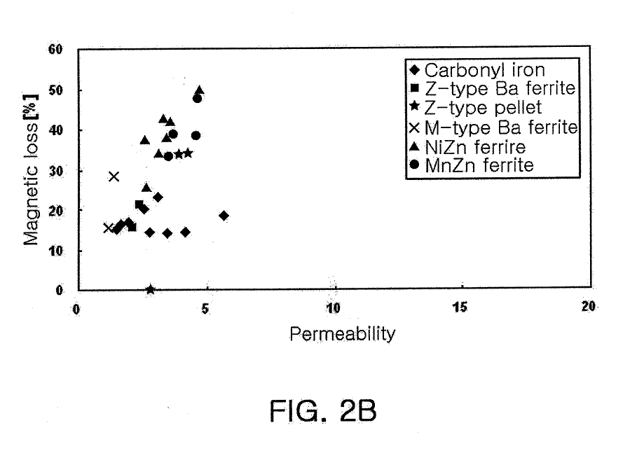

FIGS. 2A and 2B are graphs illustrating dielectric properties and magnetic properties of various soft composite materials mixed with various types of magnetic powder, respectively. Here, a silicone resin is used as a polymer resin.

As shown in FIGS. 2A and 2B, the soft magnetic composite materials are varied slightly in dielectric loss according to permittivity but varied very greatly in magnetic loss according to permeability. Therefore, according to the present embodiment, magnetic loss serves more for controlling the antenna characteristics than dielectric loss. Also, as shown in FIGS. 2A and 2B, various types of magnetic powder such as a magnetic metal powder or a ferrite powder can satisfy conditions of the present embodiment.

Frequency characteristics of an antenna will be described by way of second to fourth examples.

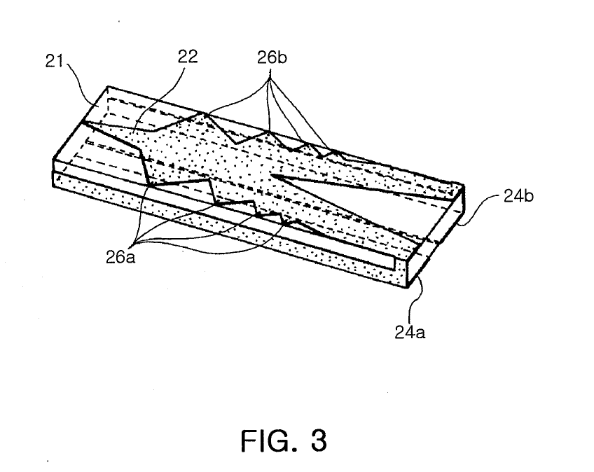

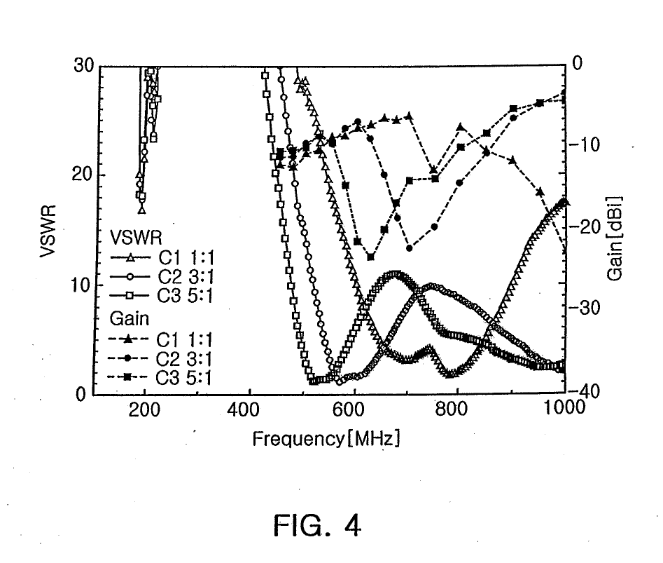

As shown in FIG. 3, each of antennas employed in the examples below is structured such that a radiator is disposed on a surface of a body in the form of a rectangular parallelepiped block.

A broad band antenna structure 20 used in the examples below will be described roughly with reference to FIG. 3. The broad band antenna structure 20 includes a body 21, and a first radiation pattern 22 and second radiation patterns 24a and 24b formed on opposing sides of the body 21, respectively. The first radiation pattern 22 and the second radiation patterns 24a and 24b are connected together to function as a single radiation pattern. The first radiation pattern 12 includes a tapered slot opened at one side and has four pairs of log periodic patterns 16a and 16b.

The second and third examples adopt antennas structured in FIG. 3. Various frequency characteristics other than size reduction and bandwidth increase described in the first example were measured to identify actual applicability of the antennas. In fact, frequency characteristics may be complicated depending on permittivity and permeability. This is because with higher permittivity and permeability, a Q value increases but may potentially decrease due to increase in loss.

Therefore, appropriate permittivity and permeability should be selected as in the aforesaid conditions of the present example. Under the conditions of the present example, adequate gain may be obtained at a usable frequency band or gain may be increased to a desired level by a matching circuit. This will be confirmed by examples below.

### Example 2

In second example, carbonyl iron powder and a silicon resins were mixed at adequate ratios to prepare soft magnetic composite materials used in antenna bodies (40×10×2.5 mm).

That is, the carbonyl iron powder and the silicone resin were mixed at a ratio of 1:1(C1), 3:1(C2), and 5:1(C3), respectively. The carbonyl iron powder was added by 50 wt %, 66.5 wt %, and 83.3 wt % with respect to a total weight of each of the soft magnetic composite materials.

Similarly to the results of Example 1, a higher ratio of the carbonyl iron powder increased permittivity and permeability (magnetic loss), thereby leading to a low band frequency, i.e., size reduction effects.

In antennas manufactured according to the second example, VSWR and gain thereof are influenced by not only magnetic loss of the materials but also permittivity and permeability and thus shown a bit complicated. The antennas exhibit somewhat high gain at a usable frequency band with a VSWR of 3 or less.

Considering the results of the second example and characteristic differences among magnetic substances, in a case where carbonyl iron is employed as a magnetic powder, the composite material may contain the magnetic powder by 45 to 85 wt % with respect to a total weight.

### Example 3

In third example, a NiZn ferrite powder and a silicone resin were mixed at adequate ratios to prepare soft magnetic composite materials used in antenna bodies (40×10×2.5 mm).

That is, the NiZn ferrite powder and the silicone resin were mixed at a ratio of 3:1(N1), 5:1(N2), 7:1(N3), and 9:1(N4), respectively. When converted into weight percent, the NiZn ferrite powder is construed to be added at a varying ratio of 50 wt % to 90 wt %.

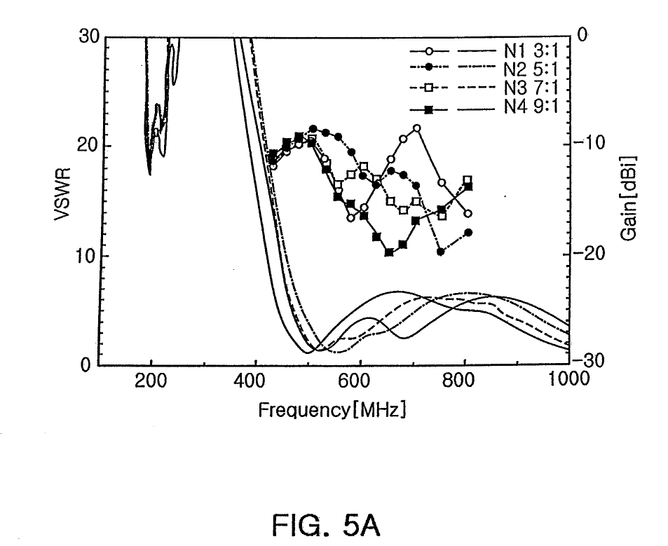

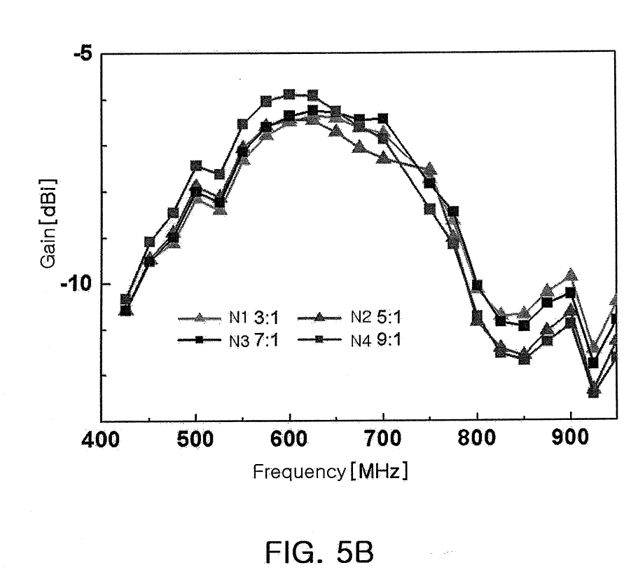

In general, the NiZn ferrite powder has a magnetic loss tangent higher than those of other magnetic powders, e.g., carbonyl iron, thus expected to be limited in its use. Meanwhile, in a case where the NiZn ferrite powder is mixed with the silicone resin of polymer into the soft magnetic composite materials to be applied to antennas as designed in FIG. 3, the antennas exhibit relatively lower gain as shown in FIG. 5A.

However, this low level can be improved to a desired level by a simple matching circuit. Therefore, the antennas of the third example may be beneficially employed in a mobile telecommunication terminal.

Considering results of the third example and characteristic differences among magnetic substances, in a case where the NiZn ferrite is used as a magnetic powder, the composite material may contain the magnetic powder by 45 to 90 wt % with respect to a total weight.

### Example 4

In fourth example, a Z-type Ba ferrite and a silicone resin were mixed at adequate ratios to prepare soft magnetic composite materials used in antenna bodies (40×10×2.5 mm).

That is, the Z-type Ba ferrite powder and the silicone resin were mixed at a ratio of 3:1(Z1), 5:1(Z2), and 7:1(Z3), respectively. When converted into weight percent, the Z type Ba ferrite powder is construed to be added at a varying ratio of 50 wt % to 87.5 wt %.

In general, the Z type Ba ferrite powder is lower in permittivity and permeability than other magnetic powders, e.g. carbonyl iron, thus low in a magnetic loss tangent. Therefore, the Z type Ba ferrite powder may be less effective than other magnetic powders in terms of miniaturization or lower band frequency. However, very high temperature stability of the Z type Ba ferrite powder may serve to significantly improve reliability.

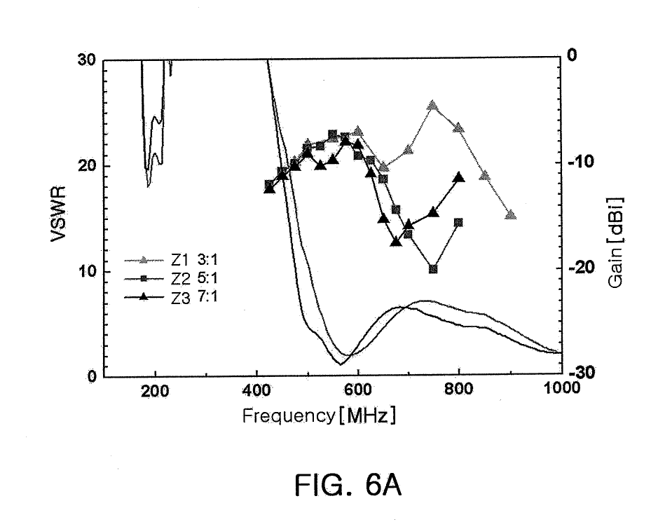

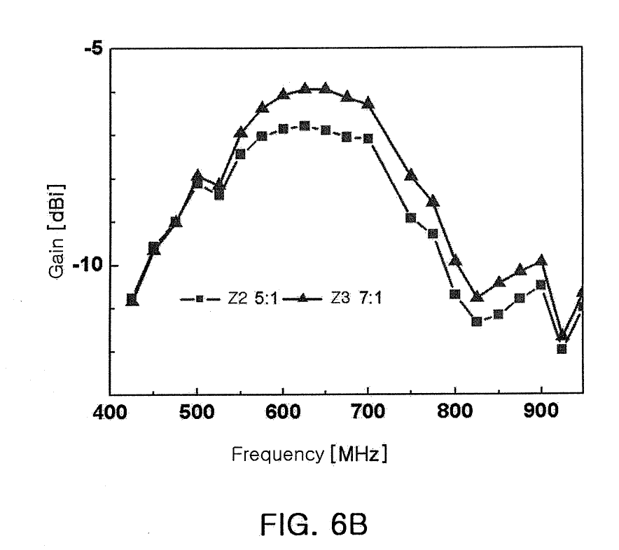

In a similar manner to the third example, as shown in FIG. 6A, antennas of the fourth example demonstrate relatively lower gain. But this low level can be improved to a desired level by a simple matching circuit as shown in FIG. 6B.

Considering results of the fourth example and characteristic differences among magnetic substances, in a case where the Ba ferrite is used as a magnetic powder, the composite material may contain the magnetic powder by 50 to 87.5 wt % with respect to a total weight.

Particularly, in a case where the Ba ferrite is used for the soft magnetic composite material, an upper limit of a mixing ratio of the magnetic powder is understood to be set to a level where radiation properties are not degraded by increase in electrical conductivity of the antenna body.

As set forth above, according to exemplary embodiments of the invention, a magnetic substance is employed to realize a smaller antenna. Also, magnetic loss of the antenna is controlled without a big decrease in gain to attain broadband characteristics. This assures a commercially viable smaller-sized antenna having broadband characteristics at a low frequency band.

While the present invention has been shown and described in connection with the exemplary embodiments, it will be apparent to those skilled in the art that modifications and variations can be made without departing from the spirit and scope of the invention as defined by the appended claims.

What is claimed is:

1. A broad band antenna comprising:
a body formed of a material having a relative permittivity of 2 to 20, a relative permeability of 1 to 10, and a magnetic loss tangent of 0.001 to 0.2, at a usable frequency; and
at least one radiator disposed on the body.

2. The broad band antenna of claim 1, wherein the material forming the body is a composite material formed of a polymer resin mixed with a magnetic powder.

3. The broad band antenna of claim 2, wherein the composite material contains the magnetic powder by 90 wt % with respect to a total weight.

4. The broad band antenna of claim 2, wherein the magnetic powder comprises a magnetic substance having at least one element selected from Fe, Ni, Co, Mn, Mg, Ba, Sr and Zn.

5. The broad band antenna of claim 4, wherein the magnetic powder comprises at least one selected from carbonyl iron, a Ba ferrite, a NiZn ferrite and a MnZn ferrite.

6. The broad band antenna of claim 5, wherein the magnetic powder is the carbonyl iron and the composite material contains the magnetic powder by 45 to 85 wt % with respect to a total weight.

7. The broad band antenna of claim 5, wherein the magnetic powder is the NiZn ferrite and the composite material contains the magnetic powder by 45 to 90 wt % with respect to a total weight.

8. The broad band antenna of claim 5, wherein the magnetic powder is the Ba ferrite and the composite material contains the magnetic powder by 50 to 87.5 wt % with respect to a total weight.
